(19) United States
(12) Patent Application Publication
(10) Pub. No.: US 2015/0206126 A1
(43) Pub. Date: Jul. 23, 2015

(54) AUTHENTICATION METHOD AND SYSTEM

(71) Applicants: CARGONIS GmbH, Lübeck (DE); ROCKHARD BUSINESS CONCEPTS AND CONSULTING CC, Cape Town (ZA)

(72) Inventor: Friedrich Christoph Zeinecker, Ratzeburg (DE)

(73) Assignee: ROCKHARD BUSINESS CONCEPTS AND CONSULTING CC, Cape Town (ZA)

(21) Appl. No.: 14/421,631

(22) PCT Filed: Aug. 16, 2013
(86) PCT No.: PCT/EP2013/067199

§ 371 Date: Feb. 13, 2015

(30) Foreign Application Priority Data
Aug. 16, 2012 (ZA) 2012/06169

(51) Int. Cl. G06Q 20/32; G06Q 20/40; H04W 12/06

(52) U.S. Cl. CPC G06Q 20/3255; H04W 12/06; G06Q 20/4014

(57) ABSTRACT

A method and a system authenticate an identity of an entity or a user (16) transacting with a remotely accessible transaction host (10). A first message (32), encoded using a first transaction verification code, including a verification response address associated with the transaction host, is transmitted over a first communication channel (20) to a remote client device (18). A verification response number (address) is provided for communication from a remote communication device (22) with the transaction host over a second communication channel (26) with a second message (36) encoded by using a second transaction verification. The first and second transaction verification codes are compared. The identity of an entity or a user having transmitted the second message is authenticated, if the second message, received by the transaction host at the verification response address, has the second transaction verification code correspond to the first transaction verification code.

### CROSS REFERENCE TO RELATED APPLICATIONS

This application is a United States National Phase Application of International Application PCT/EP2013/067199 filed Aug. 16, 2013 and claims the benefit of priority under 35 U.S.C. §119 of South Africa Patent Application ZA 2012/06169 filed Aug. 16, 2012, the entire contents of which are incorporated herein by reference.

### FIELD AND BACKGROUND OF THE INVENTION

The present invention relates to a method and a system for authenticating the identity of an entity or a user transacting with a remotely accessible transaction host.

### SUMMARY OF THE INVENTION

It is an object of the present invention to provide an authentication method and system which is simply to operate by ensures a high security.

In order to achieve the aforementioned and further objects, in accordance with a first aspect of the present invention, there is provided a method for authenticating the identity of an entity or a user transacting with a remotely accessible transaction host, wherein at the transaction host carried out are the steps of transmitting over a first communication channel a first message including at least a verification response address associated with the transaction host to a remote client device, said first message being encoded by using a first transaction verification code, and said verification response number being provided for communication from a remote communication device with the transaction host over a second communication channel, receiving a second message over the second communication channel from said remote communication device, said second message being encoded by using a second transaction verification code and having been transmitted to the verification response address, comparing the first and second transaction verification codes, and authenticating the identity of an entity or a user having transmitted said second message, if said second message was received by the transaction host at the verification response address and the first and second messages match at least in so far as the second transaction verification code used for encoding said second message corresponds to the first transaction verification code used for encoding said first message.

Moreover, in order to achieve the aforementioned and further objects, in accordance with a second aspect of the present invention, there is provided a system for authenticating the identity of an entity or a user transacting with a remotely accessible transaction host, including a transaction host which comprises means for transmitting over a first communication channel a first message including at least a verification response number associated with the transaction host to a remote client device, said first message being encoded by using a first transaction verification code, and said verification response address being provided for communication from a remote communication device with the transaction host over a second communication channel, means for receiving a second message over the second communication channel from said remote communication device, said second message being encoded by using a second transaction verification code and having been transmitted to the verification response address, means for comparing the first and second transaction verification codes, and means for authenticating the identity of an entity or a user having transmitted said second message, if said second message was received by the transaction host at the verification response address and the first and second messages match at least in so far as the second transaction verification code used for encoding said second message corresponds to the first transaction verification code used for encoding said first message.

In accordance with a third aspect of this invention, there is provided an electronic rating system for rating goods and services, the system comprising a remotely accessible server in data communication with a central database; a remotely accessible user interface accessible by a user over a first communications channel and operable to enable a user of the system to browse goods and services uploaded and stored on the database and submit a rating for selected goods and services; and a rating authentication module operable to authenticate the identity of the user utilizing a second, independent communication channel, prior to accepting the rating.

Further features of the invention provide for the authentication module to further be operable to transmit a message to the user, the message containing at least a first transaction verification code and a verification response number associated with the authentication module; to receive a second transaction verification code over the second communication channel, the second verification code having been sent to the verification response number by the user; to compare the first and second transaction verification codes; and, in response to the first and second verification codes matching, accepting the rating, thus allowing it to be associated with the goods or services being rated.

Still, further features of the invention provide for the authentication module to further be operable to transmit the message to the user over the first communication channel, alternatively over the second communications channel to a mobile phone number provided by the user and registered to the user on the central database.

Still, further features of the invention provide for the rating authentication module to further be operable to prevent multiple ratings to be submitted by a user associated with a single mobile device number, at least for a predetermined period of time; for the second communication channel to be a mobile phone network; for the first communication channel to be the Internet; and for the message to be selected from the group including an SMS message, an MMS message, an USSD message, an e-mail message, a notification message displayed in the user interface, or the like, transmitted by the rating authentication module by means of a communications module associated with the system over the first or second communications channels, as the case may be.

In accordance with a fourth aspect of the invention, there is provided a distributed commercial network comprising a network server remotely accessible by means of a user interface over a communications network, the network server being in data communication with a system database; a user registration module associated with the server and operable to enable a user to register and create a user account on the network by means of which the user is enabled to interact over the network; a transaction module operable to enable registered users to browse, purchase, request and/or offer goods and services on the network to or from other users of the network; and a goods and services rating system as described above, the network server further being operable to store data of the registered users of the network and aggregate ratings of goods and services transacted with on the network in the database and to make such information available for viewing by users of the network by means of the user interface.

A further feature of the invention provides for the user registration module to require registered users to submit personal information including at least a mobile phone number prior to activating the user's account, the mobile phone number being used by the goods and services rating system to authenticate the identity of the user each time the user wishes to submit a rating in respect of goods or services.

Still, further features of the invention provide for the network to be configured to provide registered users with credits in exchange for submitting ratings on goods and services on the network; for such credits to be virtual credits; for the server to require registered users to pay for viewing ratings of goods and services; and for the server to accept virtual credits or real currency as payment.

Yet, further features of the invention provide for the network server to further be operable to enable selected users to operate as network administrators; for the network administrators to have additional network functionality available to them; for the additional network functionality to include the adding of new rateable goods and services to the database, the validation of ratings received from other registered users, the monitoring of suspicious registered user activity, the marketing of the network, as well as the recruitment of new users and advertisers; for the administrators to receive virtual or monetary credits for performing any of these operations; for the administrator to receive a percentage of a newly recruited user's virtual or monetary credits; and for the administrator's privileges to be reduced, limited or removed altogether should their activity on the network decline to below a predetermined level.

Further features of the invention provide for the network to make a plurality of additional applications available to registered users by means of which users may interact with each other, as well as conduct a variety of commercial activities; and for the applications to include any one or more of employment services, service offerings, price comparisons, equipment sharing, insurance related goods and services, and the like.

In accordance with a fifth aspect of the invention, there is provided a method of authenticating a rating of goods and services available on a remotely accessible database, the rating being supplied by a user over a first communications channel, the method including the steps of transmitting a message to the user, the message containing a first transaction verification code and a verification response number associated with the authentication module; receiving a second transaction verification code over a second communication channel, the second verification code having been sent to the verification response number by the user; comparing the first and second transaction verification codes; and accepting the rating if the first and second verification codes match.

Further features of the invention provide for the step of transmitting the message to include transmitting it over the first or second communication channels; and for the step of receiving the second transaction verification code over the second communication channel to include receiving it over a mobile phone network by means of an SMS message.

In the following, preferred embodiments of the present invention are described by referring to the enclosed drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic illustration of an authentication system according to a first preferred embodiment of the present invention;

FIG. 2 is a schematic illustration of an authentication system according to a second preferred embodiment of the present invention;

FIG. 3a is a view showing an end-user-client provided as a laptop and a smartphone displaying certain information during a login authentication process;

FIG. 3b is a view showing an end-user-client provided as a laptop and a smartphone displaying certain information during a transaction authentication process;

FIG. 4a is an end-user-client provided as a laptop and a mobile phone of an older type without any smartphone features displaying certain information during a login authentication process; and

FIG. 4b is an end-user-client provided as a laptop and a mobile phone of an older type without any smartphone features during a transaction authentication process.

### DESCRIPTION OF THE PREFERRED EMBODIMENTS

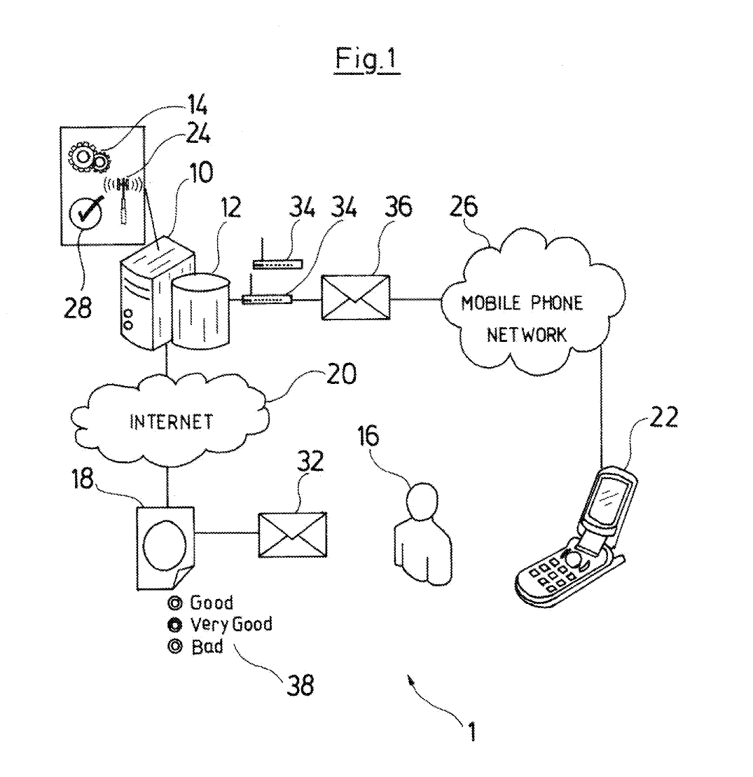

A distributed commercial network or network system 1 in accordance with a first preferred embodiment of the present invention is shown in FIG. 1. In this embodiment, the network 1 includes a remotely accessible network server 10, which has associated with the network 1, a database 12 and a user registration module 14, configured to enable users 16 of the network 1 to register and create user accounts on the network 1. A user interface 18 enables users to access and interact with the network 1 over the Internet 20 from any Internet enabled device such as a personal computer, laptop, Internet enabled mobile phone, tablet, PDA, a vending machine, a payment terminal, a cash dispensing machine (ATM) or any other online terminal client capable of displaying or outputting an information; usually the user interface 18 is included in such a device which as a whole can be alternatively designated by the reference numeral “18” since the user interface function plays an important role with respect thereto. Upon registration, the user 16 is required to submit personal information to the registration module 14, which is stored against the user's personal account and which includes at least mobile phone 22 or other device number by means of which messages may be transmitted to the user 16 from a communication module 24 included in or at least connected to the server 10, over a mobile phone network 26. The communication module 24 is connected to a plurality of communication gateways 34, each with a unique communication number.

Further, the communication module 24 is also configured to enable registered users to browse, purchase, request and/or offer goods and services on the network to or from other users of the network. Information relating to registered users 16 as well as rating data of a plurality of goods or services are also stored on the database 12.

The network 1 further includes an authentication module 28 by means of which registered users 16 can rate goods and services uploaded by other users to the network 1.

In use, registered users 16, of the network 1, are able to log onto their user accounts on the network using credentials received or chosen during initial registration for the service, interact with other users of the network and browse and view information related to the goods and services available on the database 12. Users 16 are then allowed to select goods and services from the database 12 that they have used or bought or have other personal experience of and rate those goods and services based on their experience and level of satisfaction therewith. Before a user's rating is, however, accepted and utilized by the network, the authentication module 28 opens an authentication session and transmits a first message 32 via the Internet 20 to the user interface 18. The first message 32 includes a transaction verification code which is generated by the authentication module 28, a verification response number (address) to which the user 16 is to reply, the verification response number being associated with the authentication module 28, as well as other information relating to the rating the user 16 is in the process of submitting. The verification response number is the communication number of anyone of the communication gateways 34. For ease of reference the transaction verification code will be referred to as a One-Time-Pin (“OTP”).

The user is then requested by means of either the user interface 18 or the first message 32 itself, to transmit the OTP to the verification response number. An OTP containing a second message 36 is sent in the form an SMS message from the mobile phone 22 associated with the mobile phone number registered by the user 16 against his or her account, to the verification response number over the mobile phone network 26. On receipt of the OTP by a gateway 34 associated with the authentication module 28, the authentication module 28 analyses the number from which the second message 36 originated, the gateway 34 through which the second message 36 was received and compares the OTP with the originally transmitted OTP. If the OTP was sent during an open authentication session to the correct verification response number from the correct mobile number, and the OTP matches the OTP that was originally transmitted, the rating provided by the user 16 is accepted and taken into account during calculation of an aggregate rating which the network 1 signs to the relevant good or service that was rated. The authentication session is then closed. It should be appreciated that the network 1 may have a limited number of rating options to simplify the rating process and to ensure conformity of the ratings from the various users. To do so, the user interface 18 may therefore simply provide three options 38, namely “good” which means the product or service met the user's expectations, “very good” which means the user's expectations were exceeded, and “bad” which means that the user 16 was disappointed with the given good or service.

It should immediately be appreciated that while the user 16 is interacting with the network 1 over a first communication channel, in most cases the Internet 20 as shown in FIG. 1, the user 16 transmits the confirmation message to the authentication module 28 by means of a separate second communication channel, in this example shown in FIG. 1 a mobile phone network 26. The authentication of the rating over a separate second communication channel 26 significantly improves the authenticity of the rating, and as a one to one relationship is assumed to exist between a user 16 and his or her mobile phone 22, the user 16 can be verified by means of the provider of the mobile phone network 26 to be who he or she purports to be. The system therefore significantly reduces the risk of goods or services having fraudulent or manipulated ratings. The ratings will therefore reflect the true aggregate user experience of the goods or services and can be trusted by network users.

It should further be appreciated that the second message 36 may be in the form of a Short Messaging Service (SMS) message, a Multimedia Message Service (MMS) message, an Unstructured Supplementary Service Data (USSD) message, an e-mail message, or the like. The type of the second message 36 used however needs to be operable on the mobile phone 22 of the user 16.

The plurality of GSM gateways 34, each with a different mobile phone number, to which the user 16 may be able to submit a transaction confirmation message, may further enhance the security of the rating system. The applicable GSM gateway 34 will however only be identified to the user 16 by the inclusion of its associated number in the initial first message 32 transmitted to the user interface 18 and, hence, sent to the user 16. The specific gateway 34 used will preferably be selected on a random basis.

Furthermore, the first message 32 containing the OTP may also be sent to the user 16 over the second communication channel in a format operable on the mobile phone 22 of the user 16, such as an SMS message, MMS message, USSD message, e-mail message or the like. The user 16 will still be required to reply with the OTP over the second communication channel in the same way as described earlier.

Should an authentication session be opened and a transaction not be successfully completed within a specified time limit, the authentication module 28 will typically terminate the authentication session. The user 16 may be informed that the rating was not accepted due to this, and will be allowed to re-submit a rating in a new authentication session.

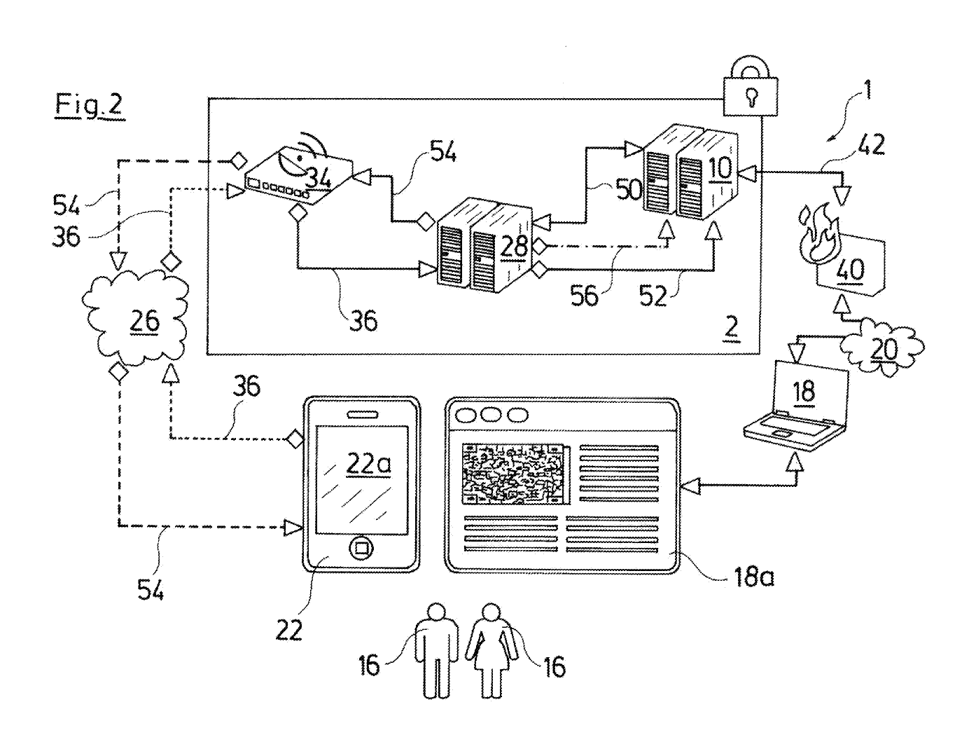

FIG. 2 shows a distributed, commercial network or network system 1 in accordance with a second preferred embodiment of the present invention wherein identical reference numerals are used for designation of components having the same function as the corresponding components of the first embodiment. So, in the second embodiment of the present invention, the network 1 includes a remotely accessible network server 10 which is running a core software application (like e.g. a rating application, an online banking application etc.) and is therefore also called a transaction-application-server. Like in the first embodiment, a database, a user registration module and a authentication module 28 are provided; however, in the second embodiment, the data base and the user registration module are part of the server 10, i.e. included therein, and therefore not shown in FIG. 2, whereas different from the first embodiment the authentication module 28 is not part of the server 10, but provided as a separate authentication server connected to the network server 10. As further indicated in FIG. 2, the network server 10, the authentication server 28 and the gateways 34 are embedded in a secured environment 2 protected by a firewall 40 which is connected to the network server 10 via a wired connection 42 and provided between the network server 10 and the Internet 20.

An end-user-client is provided to enable the users 16 to access and interact with the network 1 over the Internet 20. Since the end-user-client includes a user interface which has the same function as the user interface 18 of the first embodiment and plays an important role, the end-user-client of the second embodiment as a whole is designated by the same reference numeral “18” here. The end-user-client 18 may be embodied as a personal computer, laptop, Internet enabled mobile phone, tablet, PDA, a vending machine, a payment terminal, a cash dispensing machine (ATM) or any other device which is able to serve as an online terminal client and to display or output an information. In FIG. 2 the end-user-client 18 is shown as a laptop. Upon registration, the user 16 is required to submit a personal information to the network server 10 including the data base and the registration module wherein the personal information is stored against the user's personal account and further at least a number of the mobile phone 22 or any other communication device is stored, by means of which messages may be transmitted to or from the user 16 from or to a communication module, over the mobile phone network 26. The communication module, which is not shown in FIG. 2, is connected to the network server 10 and may be included therein and is further connected to a plurality of communication gateways 34, wherein, however, in FIG. 2 for the sake of simplicity only a communication gateway 34 is shown as an example. Each communication gateway 34 has a unique communication number associated therewith. Preferably, the communication gateways 34 are provided as mobile phone/GSM gateways, each having a different mobile phone number as a unique communication number.

In order to login to the secured section of the respective application in the network server 10, the user 16 needs to have registered her/his mobile phone 22 in a One-Time-Pin (“OTP”) registration process with the authentication server 28. After such an initial device registration, the access to the secured login-area only requires the number of the mobile phone 22 as unique identification.

As soon as the user 16 submits the number of his/her mobile phone 22 via the Internet 20 to initiate the login process, the network server 10 initiates an authentication session 50 to the authentication server 28 by providing the number of the mobile phone 22 of the requesting user 16 and in case of a transaction authorization key transaction details to be authorized and matched.

The details of the mobile phone 22 to be stored in the database of the network server 10 comprise not only the phone number, but also the SIM card number and the device IMEI number. Based on these registered SIM card and IMEI numbers, the authentication server 28 creates a first message which can be also called authentication challenge and corresponds to the first message 32 according to the first embodiment as shown in FIG. 1. Preferably, the first message 32 is provided in form of a two-dimensional rendered image information including any kind of a bar-code, QR-code or alphanumeric code. The first message 32 contains a transaction relevant information, which in particular include specific user's data, encoded by using key data representing the specific identification details or properties of the user's mobile phone 22 including the phone number, the SIM card number and the IMEI number. So, in particular, the SIM card number and the IMEI number, which both define unique data for individually characterizing the registered mobile phone 22, are used for providing a unique authentication ID and therefore for providing a unique first transaction verification code by means of which the first message 32 is encoded.

The rendered two-dimensional image code forming the first message is supplied from the authentication server 28 to the network server 10 and transmitted from the network server 10 via the Internet 20 to the requesting end-user-client 18. The end-user-client 18 comprises a screen 18a where the first message in form of the rendered two-dimensional image code is displayed. So, in the shown embodiment, the authentication process is handled through an IP protocol via the Internet 20.

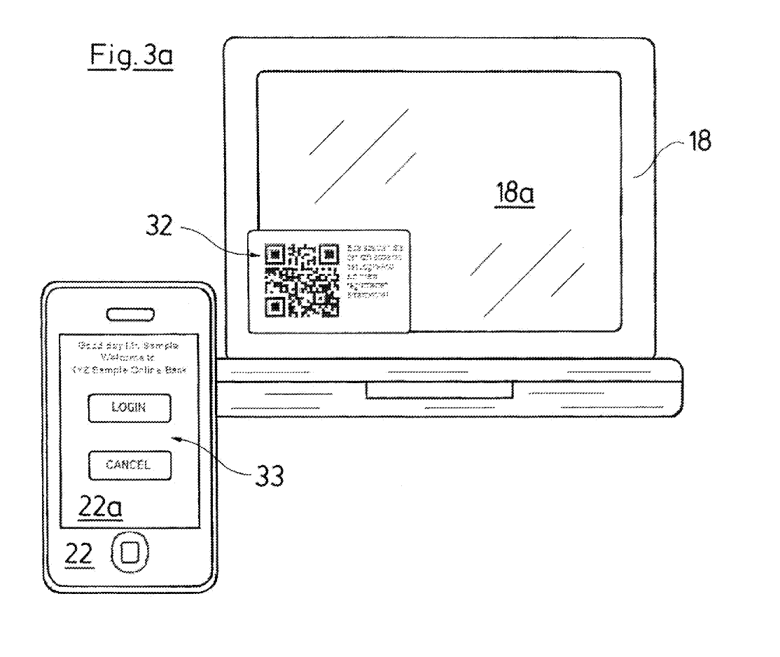

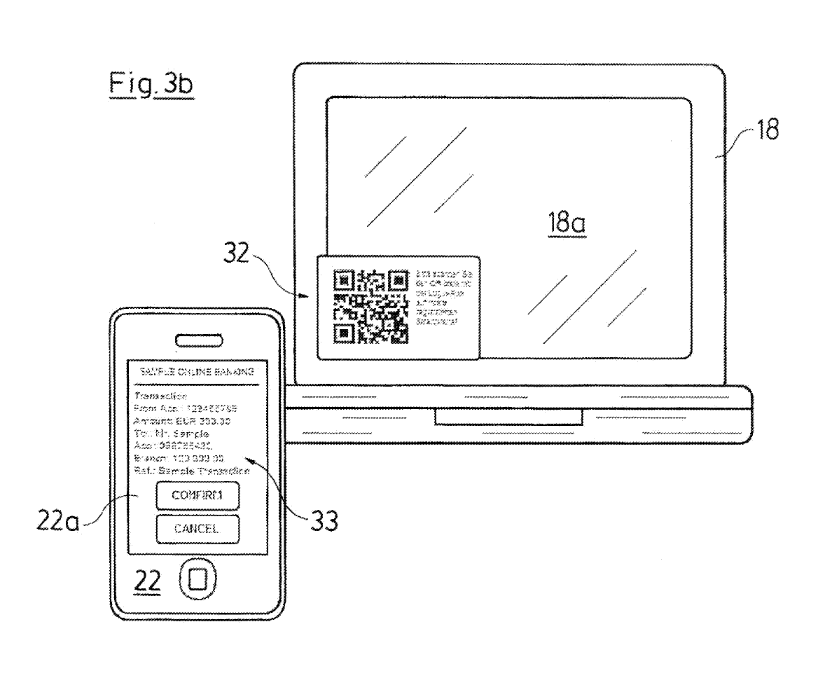

As shown in FIG. 3a, the first message 32 in form of the two-dimensional image code including the encoded information is displayed on the screen 18a of the end-user-client 18. Now, the user 16 is required to have her/his mobile phone 22 registered in the system on hand in order to be able to process the information included in the first message 32 as displayed on the screen 18a of the end-user-client 18. Of course, the mobile phone 22 needs to be registered in the mobile phone network 26.

Preferably, the mobile phone 22 as in particular depicted in FIGS. 3a and 3b is a smartphone having a camera or any other image capturing unit for capturing images. A smartphone app which as a special software is part of the used authentication system is provided to be installed in the smartphone 22 for further processing of the authentication session.

Now, the user needs to scan the image code of the first message 32 displayed on the screen 18a of the end-user-client 18 with her/his mobile phone 22 by means of the camera thereof. The smartphone app in the mobile phone 22 decodes the scanned image code by using the intrinsic specific identification properties or details of the smartphone 22 including the SIM-card number and the IMEI number. If the scanned image code has been successfully encoded by the smartphone app in the mobile phone 22, the smartphone app displays a correctly readable transaction information 33 on the screen 22a of the registered mobile phone 22 with the request to confirm (“LOGIN”) or cancel (“CANCEL”) the transaction, as additionally shown in FIG. 3a.

If the user 16 confirms the transaction with his/her registered mobile phone 22, by touching or pressing the “LOGIN” button on the touchscreen 22a of the mobile phone 22 shown in FIG. 3a, so as to generate an authorization information, the smartphone app in the mobile phone 22 will encode this authorization information by using again the mobile phone identification properties including the SIM-card number and the IMEI number. The result is a specific code which serves as a lean authorization key and forms the second message 36 corresponding to the second message 36 of the first embodiment. The second message 36 also contains a transaction relevant information, which e.g. includes a login confirmation (cf. FIG. 3a), which information is encoded by using key the data representing the specific identification details or properties of the currently used mobile phone 22 including the phone number, the SIM card number and the IMEI number. So, in particular, the SIM card number and the IMEI number, which both define unique data for individually characterizing the user's mobile phone 22 currently used, are taken for providing a unique authentication ID again and therefore for providing a unique second transaction verification code by means of which the second message 36 is encoded.

So, the encoding by using the unique identification details or properties of the mobile phone 22 is carried out twice. Both the first and second transaction verification codes are not transmitted along with the first and second messages 32, 36 which would be very disadvantageous for the security, but are locally stored and processed. In the server 10 stored and processed is the first transaction verification code which is defined by the SIM card number and the IMEI number preferably along with the mobile phone number of the registered mobile phone. Remotely and separately from the server 10 and the first transaction verification code stored therein, the second transaction verification code is processed in the mobile phone 22 in which the SIM card number and the IMEI number are intrinsically stored, wherein in particular the IMEI number associated with the mobile phone 22 is very difficult to be accessed

The second message 36 is automatically sent from the smartphone 22 to a randomly chosen communication gateway 34 via the mobile phone network 26 using an Internet connection of the mobile phone network provider where the mobile phone 22 of the user 16 is registered.

So, from the mobile phone network 26 the second message 36 is transmitted to the secured environment 2 where the authentication server 28 matches the second message 36 with the first message 32 at least in so far as the second transaction verification code used for encoding the second message 36 corresponds to the first transaction verification code used for encoding the first message 32 which has been created at the beginning of the authentication session as mentioned above. If the matching is successful, the authentication server 28 sends a positive “Authentication Successful” message 52 to the network server 10 where the login is completed successfully.

At the same time, the authentication server 28 also sends a feedback message 54 via the communication gateway 34 and the mobile phone network 26 to the mobile phone 22 of the user 16.

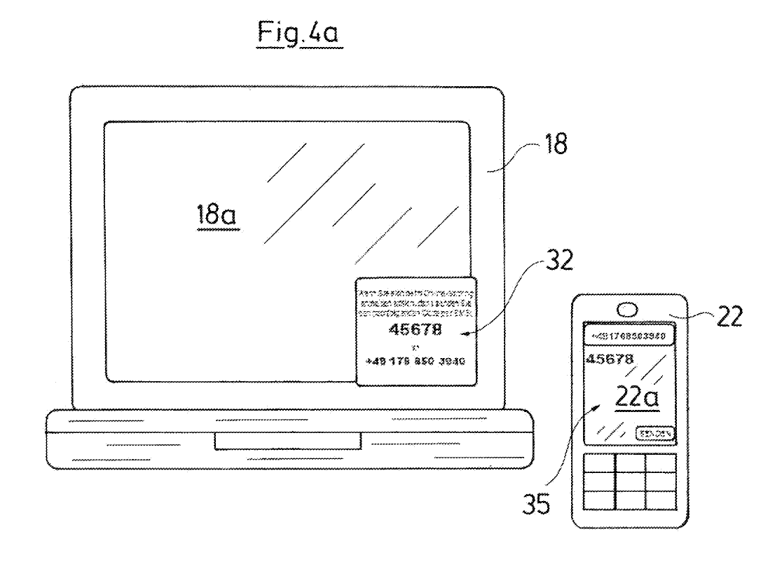

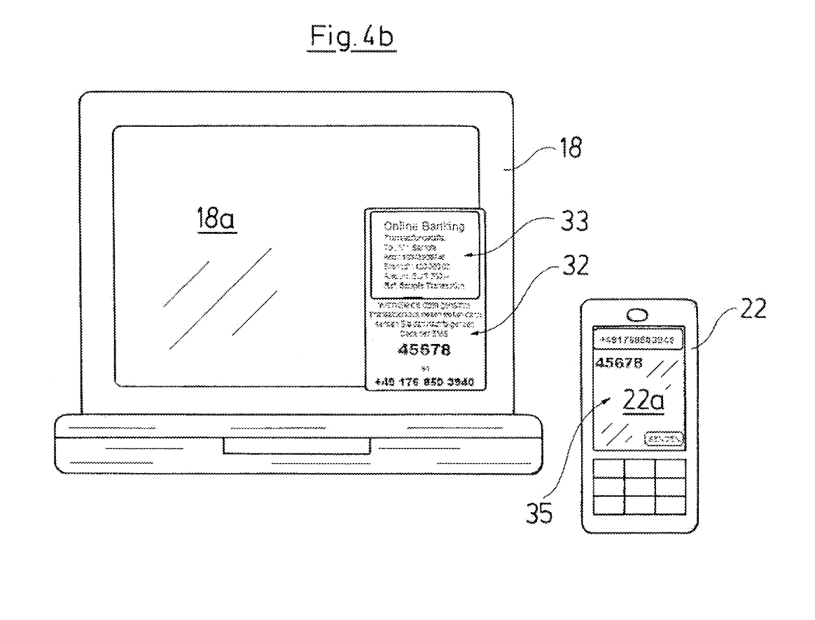

In case the mobile phone 22 is not a smartphone but in particular of an older type which is not able to capture images and to have smartphone apps installed therein, the SMS service must be alternatively used according to a modification of the second preferred embodiment. Using the authentication process with the SMS service works almost in the same way. Different from using a smartphone with the aforementioned smartphone app, the first message 32 is not provided as an image code but as an alphanumeric code which is displayed along with a recipient telephone number on the screen 18a of the end-user-client 18 as shown in FIG. 4a. The user 16 creates a new SMS message 35 in his/her registered mobile phone 22 by manually inputting said alphanumeric code to be seen from the screen 18a of the end-user-client 18 into the new SMS message as also indicated in FIG. 4a. Once the new SMS message containing the alphanumeric code is completed, the user 16 sends it to the recipient telephone number which is additionally displayed on the screen 18a of the end-user-client 18 as shown in FIG. 4a according to the instructions also displayed on the screen 18a of the end-user-client 18. Said SMS message 35 defines a second message 36 in the same manner as the second message 36 as described above in conjunction with the first embodiment of FIG. 1 and the second embodiment of FIG. 2.

Since no software apps, and hence, no authentication process can be run on mobile phones of older type, the authentication process completely takes place outside the mobile phone 22 and mainly in the authentication server 28. The nature of using the SMS service gateway of the mobile phone network provider and therefore the CAMEL Application Part (CAP) protocol based on Customize Applications for Mobile networks Enhanced Logic (CAMEL) is that the provider of the mobile phone network 26 automatically delivers data representing the respective mobile phone identity properties including the phone number and the SIM-card number to the communication gateway 34 which serves as an SMS gateway here. Then, the authentication server 28 first verifies the identity of the delivered SMS message 36 by matching the authentication session information with the mobile phone identity details or properties delivered by the provider of the mobile phone network 26. If this matching is successful, the authentication server 28 processes the alphanumeric code received by the SMS message 36 in the same way as with the use of a smartphone as described above.

Should the authentication fail or the authentication session expire, then the authentication server 28 will send a “failed” message 56 to the network server 10.

An authentication process carried out in the network 1 shown in FIG. 2 has been described above with respect to a login procedure by referring to the FIGS. 3a and 4a. However, the authentication process can be of course used for any other applications like online banking, rating application etc.

Moreover, it is preferred to use the authentication process for a login session in a first step and for another application in a second step which application requires a login before.

This in particular applies to online banking So, in case of online banking, the authentication process is carried out in a first routine in order to authorized the login of the user as described above. After having confirmed the user's login at the end of the first authentication session, a second authentication session will run for the online banking This second authentication session is essentially equal to the first authentication session which has been described for the login procedure with reference to the FIGS. 2, 3a and 3b above. In other words, the authentication session is repeated for the online banking itself, wherein the main difference from the first authentication session for the login procedure is that the first message 32 do not include as further transaction relevant information the user's data, but the requested online banking transaction details. In case of using a smartphone 22 these transaction details are made visible on the touch screen 22a of the mobile phone 22 by the aforementioned software app as shown in FIG. 3b wherein the transaction details define a transaction information 33. Further, the smartphone app requests to confirm or cancel the transaction by displaying additional buttons “CONFIRM” or “CANCEL” to be touched or pressed accordingly.

In case the mobile phone 22 is not a smartphone but in particular of an older type which is not able to capture images and to have smartphone apps installed therein, from the first message 32 the transaction details 33 and an alphanumeric code are derived and displayed along with a recipient telephone number on the screen 18a of the end-user-client 18 as shown in FIG. 4b. When creating the new SMS message 35, the user 16 has to manually input said alphanumeric code which is associated with the requested online banking transaction.

The remaining process steps regarding the authentication session are essentially the same as in the above described login procedure carried out before.

One of the simplest means of obtaining information regarding a specific retailer, service provider or products is by means of the Internet. Many different Internet websites exist which list large numbers of related retailers, service providers and products and which can even provide comparisons between them. Typically, a user would indicate which type of service they are looking for, or which product they are interested in buying. By also indicating where they are from, the list may display to them a number of service providers or retailers in the vicinity of their choice who may be able to assist them. It is a common feature for these websites to provide rating features which allow people who at least indicate that they are familiar with the listed services, retailers or products, as the case may be, to indicate their level of satisfaction therewith or dissatisfaction therewith.

For the sake of simplicity, in the remainder of this specification, as and where appropriate, services, service providers, retailers and products offered or presented on Internet websites are collectively referred to simply as “goods and services” herein.

Unfortunately, rating systems as referred to above lend themselves to abuse. In many cases, ratings can be conducted without any need for the person conducting the rating to identify him- or herself, which allows any person to rate the goods and services, possibly as many times as they like, regardless of whether they are actually familiar therewith. In best case scenarios, a user may be required to enter a valid email address or even log into a user account to enable them to provide a rating. This still, however, does not allow the entity hosting the relevant website to determine whether a person rating the service is in fact a real person, or is providing a legitimate rating based on their experience. This may lead to fraudulent ratings being recorded on the system, which may skew a resultant overall rating of the applicable goods or services, which is intended to, and in fact does, mislead consumers into believing that the goods or services are of a better quality than they truly are.

Some companies or individuals are believed to even offer to rate the goods or services of others without having any actual knowledge thereof, in exchange for a fee. This has the inevitable result of misleading consumers. This may cause a user to select or purchase a good or service based on a rating which has been established in a fraudulent manner, resulting in the goods of services not meeting the user's expectations.

It has also become common practice for unscrupulous service providers or retailers to anonymously rate their own goods and services, often repeatedly, to increase their own ratings. This is clearly highly undesirable and not in the public interest.

In order to avoid this, the above described system can be used as a rating system for rating goods and services.

In a further preferred embodiment of the invention, users receive credits in exchange for rating goods or service. These credits may be virtual credits and are saved in the database and associated with the user's account and can be exchanged by the user to enable him or her to see the rating assigned to other goods or services available on the network. If a user does not have a sufficient number of credits available to view a rating of a particular good or service, they may pay a monetary amount to do so or they may purchase an amount of credits in exchange for viewing the rating. It is foreseen that this system of credits will incentivise users to actively interact with the network and to proactively rate goods or services provided on it in order to enable them to themselves view the ratings of other goods or services they may be interested in.

The network also allows for selected users to register as administrative users. In addition to the normal functionality available to normal registered users, administrative users may have additional system functionality available to them. These operations may include, but are not limited to, the adding of new rateable goods and services to the database, the validation of ratings received from other users, the monitoring of suspicious user activity, marketing of the network to new potential members, recruiting further administrators or advertisers, and the like. Administrators may be rewarded for the services they perform, generally in the means of a monetary value, but they may also be rewarded in credits usable against future use of the system.

If, for example, an administrator recruits another administrator, he or she may receive a percentage of the new administrator's rewards for performing operations on the network. It may also be possible for administrators to lose some of their privileges, or have some privileges limited or reduced should their activity on the system decline to a less than adequate level. The system may also provide for registered users to add new rateable services, products or retailers to the network database, in exchange for which they may receive additional credits.

It should be noted that a user will only be able to post a rating on a listed good or service if she is in possession of a mobile phone which has a SIM card inserted in it and which is registered with a mobile network provider which has issued it with a mobile phone number which the user has registered on his or her profile. As already mentioned, this greatly reduces the risk of fraudulent ratings being taken into consideration by the network for the aggregate ratings of goods or services.

It is foreseen that a large number of aspects of the network will be capable of being rated. These may include other registered users, the goods or services they offer, administrator users, the ways in which administrator users conduct themselves, the network environment itself, the functionality it provides and also the transactions conducted with the network itself. The network may accordingly be operable to allow only users with personal ratings above a predetermined threshold to have special or additional functionality. A loyalty scheme may also be included, which provides increased benefit to users with a higher rating.

The network may also provide training facilities, preferably online, to registered users or administrators to enable them to make better use of the network or to improve their own skills.

The network environment provided by this invention is also well suited to provide registered users with a variety of additional services and may have a large number of additional applications accessible by the users from the user interface. These applications may relate to, but are not limited to, employment services, job offerings, job tender services, service offerings, price comparisons, equipment sharing or lending as well as insurance-related services. It is foreseen that the applications may be available to users in an associated application store at which registered users may browse available applications, view information about them, and see ratings given to them by other users. Users may then purchase these applications after which they will be capable of being used in the network environment. It should be appreciated that the applications may be installed on top of a digital platform provided by the network environment and, once installed, may be available to the user through the normal user interface. Registered user records in the database may therefore store information about which applications the user has purchased and when the applicable user accesses her account the server will recognize the application and may adapt the user's visual interface accordingly. It should therefore be appreciated that different users may have different views of the network environment depending on which applications they have purchased.

A job seeking application may, for example, be conFigured for the posting of casual and temporary employment opportunities such as gardening, baby-sitting or watering. A potential employer may, for example, post a job advert specifying parameters related to a vacant position, for example the job outline, payment rate, location, date and duration. The job advert may be distributed by SMS to job seekers who have enrolled for or activated the application, who are registered users of the system and who match specified criteria ensuring eligibility for the available job, without disclosing the employer's details. Interested job seekers may then apply for the vacant positions by sending a reply SMS to the server. The server then screens the applicants according to a scoring system based on their response time, the length of their registration for the service, a previously determined system rating record, match of payment rates and the like. The employer may then be presented with a shortlist of top-scoring applicants by the server from which to make a selection. The employer may be able to view the full profile of each applicant. The system may be conFigured to allow an employer to select a candidate for the vacancy and for the system to inform the applicant that they have been selected. The system will then provide the contact details of the other party to both the employer and applicant to allow them to arrange further required steps to secure the positions.

Factors which may influence a job seekers score in the scoring system may include how complete their online profile is, if their qualifications are validated via certified certificates to that effect, their response time in replying to a job advert, requesting a lower compensation for performing the job, or the like.

It may also be possible for a job seeker who has performed a job to be rated by the job poster or employer, much in the same way as was described with above for goods and services. A job seeker's score in the scoring system may be influenced by their rating obtained in this manner as well.

It is also foreseen that functionality may be provided by the network by means of which employment seekers may sign up for credit checks or criminal records checks, which may be posted on their profile for a limited period of time. This will allow an employer to verify the trustworthiness of a potential candidate.

It may also be possible for job seekers to participate in online training or learning sessions, possibly related to their specific skill set. It may be possible for the job seekers knowledge to be tested on this, also online. Their completion of specific training courses may be added to their user profile, and their test results may also influence their score in the scoring system.

It should be appreciated that such a job seeking application may be advantageous for all parties involved. A simple job posting form simplifies the advertising procedure. Job applications are easily sent to job seekers, while applying for a job may be equally simple. Compensation information of multiple similar vacancies may provide employers and job seekers with a general idea of industry average payment rates. Vacancies are distributed and available to job seekers right after they are posted, reducing the need to wait for published vacancies or visit notification boards. Vacancies are only provided to job seekers having indicated that such a job might fall within their field of expertise. This will reduce the need for a job seeker to scan irrelevant advertised positions for which they are not qualified. A rating system may eliminate the need for an employer to have to contact previous employers of a job seeker in order to determine their employability. In combination with a criminal history and other background checks, a potential employer may be able to get a very good overview of the potential employee prior to them starting their employment.

The network system may also provide a central database of a job seeker's CVs, which may reduces the need for job seekers to submit their information for each vacancy for which they wish to apply. The system will may also keep record of previously completed jobs or qualifications, allowing a job seeker's CV to be continuously updated. Job seekers can likewise monitor the industry going payment rates for various jobs, allowing them to decide whether or not they may be interested in a specific job offering. By achieving a higher personal rating on the network system, job seekers may be more likely to be considered by potential employers for future vacancies. It is further envisaged that job seekers may request a previous employee to post a reference for their work on the network.

An additional application that is foreseen as being compatible with the network system is a service offering application which may be based on the same principles as a job seeking application, yet it is more specifically aimed at professional or specialized service providers such as plumbers, builders, garden services or even tax consultants, doctors, dentists or lawyers. The difference between such systems is that a tender specification is completed with the information required by the service providers to produce a detailed quotation in the form of, typically, a tender, rather than posting of an employment position. Unlike the job seeker application, the tender seeker is not just offering a labor resource but rather the delivery of a complete project, including the procurement and coordination of materials and supplies. Competition between businesses and professionals adds a layer of complexity to the operation of the application. An entity putting out a piece of work on tender may therefore decide if and when the tender process is open, at which time all tender seekers will be able to see the tender specification and submit tenders for conducting the work. The poster may also decide when the tended process will be closed and may also decide to make posted quotations available for viewing only by itself or whether to make it available for viewing by competing service providers.

As posted tenders can only be viewed on the system by registered users, the tender poster is able to upload additional information such as photos, plans or other relevant documents to help the tender seekers to refine their quotation specifications as much as possible. The system will assist the tender poster in the posting process with guidelines and templates, such as category specific information that should be considered, as well as going rates for similar projects that went out on tender. Going rates may be influence by tenders previously posted on the system.

Tender seekers may be notified that a new tender is available by SMS, email or any other suitable means. Interested tender seekers may then access the tender on the network system and may be able to request additional or clarifying information via an anonymous communication system form the tender poster. It should be appreciated that this anonymous communication system may make the additional information available to all tender seekers to avoid repeated requests for the same information and to ensure that the received quotes are all based on the same specifications.

It is also foreseen that the service offering application may include a quotation building tool for tender seekers. This tool may serve to assure the comparability of the various quotations submitted to the tender poster, as well as giving the tender seeker the option to enhance his quotation with compatible services or products offered through the network system. One of such products may be a “completion insurance” that assures the tender poster that the requested service will be completed regardless of whether the tender seeker to whom the tender was awarded is able to finally deliver the service or not.

Tender seekers may again receive a rating which may be influenced by how complete their online profile is, if their qualifications are validated via certified certificates to that effect, their response time in replying to posted tenders, for providing lower tenders that their competitors, and the like. A higher rating may be awarded to tender seekers who work according to certified quality standards (for example ISO 9001, or the like) or who are members of trade governing associations, and who have uploaded certification credentials to this effect. It is also foreseen that a company's credit-worthiness may also impact on its rating. Tender seekers may also invite previous employers or customers to rate their earlier performance on the network, which may further improve their respective ratings.

It should be appreciated that a service offering application as described above may be beneficial to all parties involved in the process. The tender poster may benefit from the simplicity of posting a tender on the network system, as well as from the fact that the system may provide him with a general idea of the costs, procedures and budgets associated with similar projects. The tender seeker, in turn, benefits from the fact that a tender can be visible to him or her immediately after it has been posted. It is also envisaged that a call centre may be provided that may provide a tender seeker with additional details that he or she may require. Tenders may also only be sent to tender seekers who have indicated that they are interested in receiving a specific type of tender, thus reducing the need for a tender seeker to consider tenders which may not be relevant to his field of expertise. To facilitate this process it is foreseen that tenders may be categorized by the network system into a number of predefined categories to which tender seekers may subscribe individually.

The rating system, validated work credentials and work history may enable a tender poster to more easily determine whether a tender seeker will be an acceptable candidate for their tender. They may also be sure of the type of service that they will receive from the relevant tender seeker based on the rating and work history which will be made available on the network system.

The service offering application may also provide for a set of guarantees for users of the system. These guarantees may include a guarantee that at least one quotation will be provided for each tender that a tender poster posts on the system. It may be possible that the tender poster will receive a subscription to use of the system for free for a limited period of time, such as one year, if no quotation can be given for a posted tender.

Another form of guarantee that may be provided by the network may be a guarantee that if the lowest quotation a tender poster receives is provided by an entity or individual that is not a subscriber to the network, he or she will be reimbursed the difference between the lowest quotation and the lowest quotation provided by a registered tender seeker of the system. A final guarantee may be that the tender poster is awarded a limited monetary amount back if the performance of a tender seeker is not acceptable.

Further benefits to tender seekers may include that, if the tender is delivered in a format receivable by their mobile phone, they may receive the posted tender right after is posted. A quotation building tool included in the system may allow a tender seeker to submit his or her tender in a standardized format. Additional complementary services may be selected by the tender seeker to be included in the tender. An open tender process may allow for a tender seeker to analyze his or her level of competitiveness, including a comparison of costs to those of other tender seekers. Validation provided for a tender seeker's qualifications may improve their chances of being awarded a tender. A high rating on the system will further improve a tender seeker's chances of being awarded a tender. A listing as a service provider on the network system may also allow the tender seeker to be awarded other employment opportunities without having to submit a tender.

It should be apparent that such a service offering application addresses the area of non-standardized service provision, which is usually inconvenient and time-consuming for a tender poster.

A still further application that may conveniently be provided as part of the network system is a price comparison application that may allow registered users to compare prices of similar or identical goods or services offered in order to select the best deal available to them. Such an application may typically consist of three core parts: a product review, a product comparison and a best deal tender part.

The application will assist registered users of the system to select the correct product, determine if the price is in line with industry standards, and also to bargain for a better price with the retailer of the product.

It is envisaged that a registered user will be able to search for a product on the network by means of a search facility, by filtering available products by relevant categories, or by scanning a quick response (“QR”) code shown in relation to the product in an advertisement or similar promotional material. Locating a product by this means on the network by means of the user interface may allow a user to access a full product overview, the overview including a rating history of the product, published articles on the product, competitive product comparisons and the like.

Price information, including price comparisons, may be linked directly to the product overview and a product comparison matrix so as to form a complete opinion building basis. The price comparison application may include most popular product or favorite product lists, as well as product alerts. It is also foreseen that the price comparison application may be configured to allow a user to post details of a product that he or she is viewing in a retail store directly to the network. Retailers registered on the network can then reply to the posting with a better deal for the same or a related product within a specific time frame, while the system will automatically sort the best counter-offers based on their distance from the user's current location. The best price offered by competing retailers on the system can then be used by the user to negotiate a better price for the product at the original retailer from where the product was posted on the system. Should the user decide not to purchase the product form the initial retailer, the network system may allow him or her to indicate, via the price comparison application, that he or she will accept the price offered by a different retailer. This service will provide a merchant with the ability to reach a potential customer while they are in a competitor's store.

Advantages of such an application to merchants may include the listing of their product in an online directory, the ability of their products to be sold online, the ability to advertise their services and products online, and provide links to their own website. Furthermore, the application may, should a user receive a better offer than the normal price of the product via use of the network, provide a user with an authorization code for the user to present at a payment point. The network system may also be expanded to provide a merchant with credit insurance. Merchants may furthermore only receive requests for product quotations if they do in fact offer those products for sale in their stores. Furthermore, merchants may advertise their products to users of a specific geographical area who have indicated that they are interested in the specific product, thereby increasing their chances of making the sale.

It is also envisaged that a merchant's rating on the network may influence its ranking order on the network. A higher rating will, for example, allow a retailer to appear higher on a list of competing retailers for a given product, above competing retailers with lower ratings. The application may further be expanded to allow a merchant to provide insurance with a product sold, increasing the desirability of such a product to a potential buyer.

Advantages of such an application to purchasers include the ability to easily access the network by means of a smartphone, and the ability to easily input information by using QR codes, a single location from which to organize his or her shopping, limiting delays in receiving quotations for products, a reduced risk of a mismatched product due to the fact that products are ensured to be similar or the same when receiving a quotation therefore, and the knowledge that the price of an advertised product is accurate, with no hidden costs. Direct competition between merchants to provide a better price for a product will also potentially drive down prices.

The application may further be accompanied by guarantees, such as a guarantee that at least one quotation will be provided to the user, and if not, that the user will be able to use the service for free for a limited period of time, for example 12 months. Another guarantee may be that if a registered user can find a product at a lower price from an entity that is not a registered user of the network than from any entity that is, the user may be reimbursed for the difference between the lower quote and the best quote from a registered provider on the network if the user agrees to buy from the registered provider. A final guarantee may be that the user may be reimbursed if a merchant is not able to provide a product for a price that has been agreed on over the network.

A further possible application that may be provided over the network is an equipment sharing application. Many households invest in expensive equipment such as lawnmowers, drilling machines, trailers and camping equipment, which they use only occasionally because they did not consider borrowing or hiring such equipment from others, of the difficulty of doing so makes it to tedious to do so.

Instead of letting bought equipment be underutilized, the equipment sharing application may offer registered users the possibility of earning a contribution towards the amortization of such equipment by renting it out to other registered users of the system. The idea behind the equipment sharing application is based on usual lending behavior. If somebody needs to borrow a lawn mower or a drilling machine this person is most likely going to approach a family member, friend or neighbor someone within their community who knows them and trusts them with their equipment. The equipment sharing application is an application where registered users can rent equipment out to other registered users. Lenders can create an inventory of the equipment they are prepared to rent out. The inventory may capture the details of the equipment such as model, manufacturer, model year, retail price (as new), purchase price by the lender, condition and service or parts history. Based on the inventory information and other information provided in respect of the equipment on the network, the network application may propose a rental rate for the listed equipment. Furthermore, the lender may create a calendar for the specific equipment which shows its availability.

Registered users who are looking for a specific piece of equipment may post an equipment request on the network in an easy and standardized format. When a new request is received by the network server, the system may scan its database for matching equipment according to availability, location preference and rental rate. The prospective renter may then be able to review the specifications and history of the equipment before booking the equipment online.

To cover the potential risk of damage to and/or loss of the equipment, the may also offer short term insurance to cover these eventualities. The premium payable toward the insurance may be calculated based on the condition and specification of the equipment (potential risk) and the rating of the renter. The lender may specify in the equipment inventory information if the rental rate includes or excludes this insurance. In both cases the dedicated insurance premium or the all-inclusive rental rate may be calculated in real time by the application.

Once the renter has booked the equipment, the application may create a rental process session that covers each step from the collection and inspection of the equipment to its safe return. The application may also require the verification consent from the parties, lender and renter, for the completion of the rental process. This may include capturing the return condition of the equipment on the system, which may form part of the system risk assessment as well.

Advantages of such an equipment sharing application to the lender may include the earning of an income in exchange for their investment, a management system for equipment that is rented out, an online list of equipment available for others to rent, and insurance cover for rented equipment.

Advantages to the renter include that they do not have to spend capital in order to obtain expensive equipment, the fact that their required equipment will be advertised to them without the need for them to search through extensive lists trying to find the right equipment, access to an online booking system for the equipment, the fact that equipment may be categorized according to geographical location, negating the need to travel extensively to pick up and drop off the equipment, as well as a managed rental system. Finally, by consulting the rating of a rentable piece of equipment, the user may know what to expect. An atomized rating system will allow ratings for products to be accurate, allowing users to know exactly what they may expect. In addition, the lender may also be able to view a perspective renter's rating to determine whether he or she feels comfortable rending the equipment to the renter concerned.

It is therefore foreseen that an equipment sharing application as described above may allow for a user-based peer-to-peer equipment usage system.

A still further possible application may be an insurance application. In this regard at least two possible approaches are envisaged. Firstly, there may be a predefined choice of insurance schemes (car, household, etc.) that are backed by an insurance partner. A range of insurance premiums may be made available based on the number of people that join the network community. A second approach may be that registered users may build their own insurance packages to suit their own needs. It is foreseen that insurance cover and premiums may be calculated based on a user's profile. By using an insurance package editor, a member may specify the object to be insured (car, person etc.), the damage event (accident, death etc.) for which he or she requires insurance, as well as the amount of insurance he or she requires. The application may then calculate a preliminary model-premium based on the profile score of the inputting member and provide a price comparison with other, existing insurance packages. The insurance package editor may then deliver a discount matrix indicating the premium discount scale linked to the number of registered users joining the insurance group.

Members may be able to choose between “fixed-premium” and “variable-premium” options. Variable-premium options may be cheaper as long as there are no damage claims within the relevant insurance group. In the event that damages are claimed, the variable premium may automatically be recalculated. Fixed premium options may be more expensive but the premium may be kept stable for a predetermined duration, for example 12 months. In the fixed premium scenario, the extended risk may be covered by a re-insurance. The fees for re-insurance may be allocated to the participating members thereby increasing the actual fixed premium amount.

Such an insurance application may be easy to understand for the insured. They will have less administration, and a group-based premium which may be lower due to a lower risk possibility.

For the insurer, such an application may require less marketing and less administration costs. Risk prediction of a client may be simplified or more accurate when taking into account a insured user's user profile and rating.

It will be appreciated that many other applications may be added to the system which will provide a user with any number of additional functionalities. Such applications may include convenience applications, for example event management applications, business innovation applications, for example agent renting applications to employ an agent to sell a user-owned article, courier applications, loan applications, as well as investment applications, to name but a few.

It should be noted that any payment on the system may take part by using virtual credits or monetary credits, providing users of the system with the option of receiving virtual credits in order to use the system, but also allow users to purchase such credits should they not have enough credits available to use the system.

It should be appreciated that the above description is by way of example only, and the numerous modification and additions may be made to the embodiments described. With respect thereto, it should be added here that one of the modifications can be a combination of the components of at least two or of all of the embodiments as described above. After all, the invention provides a commercial network which facilitates electronic commercial transactions being conducted with an increased level of user certainty and assurance

While specific embodiments of the invention have been shown and described in detail to illustrate the application of the principles of the invention, it will be understood that the invention may be embodied otherwise without departing from such principles.

1. A method for authenticating the identity of an entity or a user transacting with a remotely accessible transaction host, wherein at the transaction host carried out are the steps of:
transmitting over a first communication channel a first message, including at least a verification response address associated with the transaction host, to a remote client device, said first message being encoded by using a first transaction verification code, and said verification response address being provided for communication from a remote communication device with the transaction host over a second communication channel;
receiving a second message over the second communication channel from said remote communication device, said second message being encoded by using a second transaction verification code, the second transaction verification code having been transmitted to the verification response address;
comparing the first and second transaction verification codes; and
authenticating the identity of an entity or a user having transmitted said second message, if said second message was received by the transaction host at the verification response address and the first and second messages match at least in so far as the second transaction verification code used for encoding said second message corresponds to the first transaction verification code used for encoding said first message.

2. The method according to claim 1, wherein the first transaction verification code comprises a representation of at least one of specific identification properties of the remote communication device registered in the transaction host, and the second transaction verification code comprises a representation of at least one of specific identification properties of the remote communication device currently used.

3. The method according to claim 2, wherein the second communication channel is provided by a mobile phone network, and the remote communication device is a mobile phone.

4. The method according to claim 3, wherein said specific identification properties of the mobile phone comprise the telephone number, the SIM-card number and/or the IMEI number of said mobile phone.

5. The method according to claim 1, wherein the first communication channel is provided by the Internet.

6. The method according to claim 1, wherein the second communication channel is independent of the first communication channel.

7. The method according to claim 1, wherein the verification response address is an address or a phone number of a communication gateway associated with the transaction host.

8. The method according to claim 7, wherein a plurality of communication gateways are provided, each associated with the transaction host and having a different address or phone number.

9. The method according to claim 8, including the further step of selecting one of the plurality of communication gateways according to the address or phone number of such communication gateway defining the verification response address in the first message.

10. The method according to claim 1, wherein at the remote communication device carried out are the steps of:
receiving the first message output from the remote client device;
decoding the first message by using the first transaction verification code;
processing at least a part of the decoded first message, in accordance with the result of the processing creating the second message;
encoding the second message by using the second transaction verification code; and
transmitting the encoded second message over the second communication channel to the verification response address.

11. The method according to claim 10, wherein a software app is implemented in the communication device for decoding the first message by using the first transaction verification code, processing at least a part of the first message, creating the second message and encoding the second message with the second transaction verification code.

12. The method according to claim 1, comprising the further step of creating said first message in form of an image information comprising a bar-code or a QR-code.

13. The method according to claim 1, wherein the step of receiving the first message from the remote client device is carried out by scanning the first message by means of an optical acquisition unit provided at the communication device.

14. The method according to claim 1, wherein the second message is any one or more of the group selected from a Short Messaging Service (SMS) message, a Multimedia Messaging Service (MMS) message, an Unstructured Supplementary Surface Data (USSD) message and an e-mail message.

15. The method according to claim 1, wherein the first message further includes first transaction information to be displayed on a screen of the remote communication device.

16. The method according to claim 1, wherein the verification response address is output by the remote client device.

17. A system for authenticating the identity of an entity or a user transacting with a remotely accessible transaction host, including a transaction host which comprises:
means for transmitting over a first communication channel a first message including at least a verification response address associated with the transaction host to a remote client device, said first message being encoded by using a first transaction verification code, and said verification response address being provided for communication from a remote communication device with the transaction host over a second communication channel;
means for receiving a second message over the second communication channel from said remote communication device, said second message being encoded by using a second transaction verification code and having been transmitted to the verification response address;
means for comparing the first and second transaction verification codes; and
means for authenticating the identity of an entity or a user having transmitted said second message, if said second message was received by the transaction host at the verification response address and the first and second messages match at least in so far as the second transaction verification code used for encoding said second message corresponds to the first transaction verification code used for encoding said first message.

18. The system according to claim 17, wherein the first transaction verification code comprises a representation of at least one of specific identification properties of the remote communication device registered in the transaction host, and the second transaction verification code comprises a representation of at least one of specific identification properties of the remote communication device currently used.

19. The system according to claim 18, wherein the second communication channel is provided by a mobile phone network, and the remote communication device is a mobile phone.

20. The system according to claim 19, wherein said specific identification properties of the mobile phone comprise the telephone number, the SIM-card number and/or the IMEI number of said mobile phone.

21. The system according to claim 17, wherein the first communication channel is provided by the Internet.

22. The system according to claim 17, wherein the second communication channel is independent of the first communication channel.

23. The system according to claim 17, wherein the verification response address is an address or a phone number of a communication gateway associated with the transaction host.

24. The system according to claim 23, wherein a plurality of communication gateways are provided, each associated with the transaction host and having a different address or phone number.

25. The system according to claim 24, including the further step of selecting one of the plurality of communication gateways according to the address or phone number of such communication gateway defining the verification response address in the first message.

26. The system according to claim 17, wherein the remote communication device comprises:
means for receiving the first message output from the remote client device, means for decoding the first message by using the first transaction verification code;
means for processing at least a part of the decoded first message;
means for creating the second message in accordance with the result of the processing;
means for encoding the second message by using the second transaction verification code; and
means for transmitting the encoded second message over the second communication channel to the verification response address.

27. The system according to claim 26, wherein a software app is implemented in the communication device for decoding the first message by using the first transaction verification code, processing at least a part of the first message, creating the second message and encoding the second message with the second transaction verification code.

28. The system according to claim 17, wherein said first message is provided as image information comprising a bar-code or a QR-code.

29. The system according to claim 17, wherein the remote client device comprises a display for displaying at least a part of the first message.

30. The system according to claim 29, wherein the communication device comprises an optical acquisition unit comprising a camera, for capturing and scanning the first message.

31. The system according to claim 17, wherein the second message is any one or more of the group selected from a Short Messaging Service (SMS) message, a Multimedia Messaging Service (MMS) message, an Unstructured Supplementary Surface Data (USSD) message and an e-mail message.

32. The system according to claim 17, wherein the first message further includes a first transaction information to be displayed on a screen (22a) of the remote communication device.

33. The system according to claim 17, wherein the remote client device comprises a display for displaying and outputting the verification response address.
